(19) United States
(12) Patent Application Publication
(10) Pub. No.: US 2021/0172844 A1
(43) Pub. Date: Jun. 10, 2021

(54) UNDERWATER SAMPLING DEVICES AND METHODS

(71) Applicant: CELLULA ROBOTICS, LTD., Burnaby (CA)

(72) Inventors: James Eric JACKSON, New Westminster (CA); Don R. CLARKE, Trail (CA); Arthur TREMBANIS, Newark, DE (US); Craig CARY, Hillcrest (NZ)

(21) Appl. No.: 16/077,934

(22) PCT Filed: Feb. 17, 2017
(86) PCT No.: PCT/IB2017/000217

§ 371 Date: Aug. 14, 2018

Related U.S. Application Data
(60) Provisional application No. 62/296,462, filed on Feb. 17, 2016.

(51) Int. Cl. G01N 1/40; G01N 1/10

(52) U.S. Cl. CPC G01N 1/4077; G01N 2001/4088; G01N 1/10

(57) ABSTRACT

A sample collector includes a hollow sleeve and a removable sampler assembly within the sleeve. The sampler assembly includes a filter assembly including a filter element for filtering at least one material. The sampler assembly includes a first cover including a first sealing member to seal a first end of the filter assembly in the sleeve, and a second cover including a second sealing member to seal a second end of the filter assembly in the sleeve.

### CROSS-REFERENCE TO RELATED APPLICATIONS

This application claims priority to U.S. Provisional Application 62/296,462, filed on Feb. 17, 2016, the entire contents of which are incorporated herein by reference.

### STATEMENT REGARDING GOVERNMENT LICENSE RIGHTS

This invention was made with government support under contract No. 1235133 awarded by the National Science Foundation. The government has certain rights in the invention.

### FIELD OF THE DISCLOSURE

This disclosure is generally directed to underwater sampling devices and methods and, more particularly, to underwater sampling devices and methods for collecting biological organisms.

### BACKGROUND

Collecting biological organisms in underwater environments presents a number of challenges, particularly when attempting to collect organisms of different sizes at the same time or in close succession because doing so uses multiple filters having different granularities. Thus, it is desired to have a sampling system capable of quickly collecting and preserving samples while submersed underwater.

### SUMMARY

According to at least one example embodiment, a sample collector includes a hollow sleeve and a removable sampler assembly within the sleeve. The sampler assembly includes a filter assembly including a filter element for filtering at least one material. The sampler assembly includes a first cover including a first sealing member to seal a first end of the filter assembly in the sleeve, and a second cover including a second sealing member to seal a second end of the filter assembly in the sleeve.

According to at least one example embodiment, the sleeve, the filter assembly, the first cover and the second cover are puck-shaped.

According to at least one example embodiment, the filter assembly includes a third sealing member between the first sealing member and the second sealing member within the sleeve.

According to at least one example embodiment, the filter assembly includes a hollow slide element with a groove on an outer side surface of the slide element to hold the third sealing member, and the filter assembly includes a filter support that supports the filter element.

According to at least one example embodiment, the filter element and the filter support are flexible meshes that cover one end of the slide element and that include outer portions between the third sealing member and the groove to hold the filter element and the filter support in place.

According to at least one example embodiment, outer side surfaces of the first cover and the second cover include respective grooves, and the first sealing member and the second sealing member are in the respective grooves.

According to at least one example embodiment, the filter assembly includes a slide element to hold the third sealing member, an outer side surface of the slide element includes a respective groove, and the third sealing member is in the respective groove of the outer side surface of the filter assembly.

According to at least one example embodiment, the first, second and third sealing members are ring-shaped flexible elements, and the flexible elements corresponding to the first sealing member and the second sealing member have same inner diameters that are greater than an inner diameter of the flexible element corresponding to the third sealing member.

According to at least one example embodiment, at least one surface of the slide element is chamfered.

According to at least one example embodiment, a first end of the sleeve includes a stopper to prevent the sampler assembly from being removed from the sleeve through the first end.

According to at least one example embodiment, a second end of the sleeve includes an opening that allows for removal of the sampler assembly from the second end.

According to at least one example embodiment, the stopper is a chamfered inner edge of the first end of the sleeve.

According to at least one example embodiment, at least one of the first cover and the second cover includes a chamfered outer edge that that corresponds to the chamfered inner edge of the first end of the sleeve.

According to at least one example embodiment, at least one end of the sleeve and at least one of the first and second covers are held together at a connection point.

According to at least one example embodiment, the connection point is detent connection that includes at least one groove on an inner side surface of the sleeve that corresponds to an outer edge of at least one of the first sealing member and the second sealing member.

According to at least one example embodiment, sampler assembly includes a filter assembly including a filter element for filtering at least one material, a first cover including a first sealing member to seal a first end of the filter assembly in a sleeve, and a second cover including a second sealing member to seal a second end of the filter assembly in the sleeve.

According to at least one example embodiment, outer side surfaces of the first cover and the second cover include respective grooves, and wherein the first sealing member and the second sealing member are in the respective grooves.

According to at least one example embodiment, the filter assembly includes a hollow slide element to hold a third sealing member between the first sealing member and the second sealing member in the sleeve, an outer side surface of the slide element includes a respective groove, the third sealing member is in the respective groove of the outer side surface of the filter assembly, and the filter element is a flexible mesh that covers one end of the slide element and that includes an outer portion between the third sealing member and the respective groove of the slide element to hold the filter element in place.

According to at least one example embodiment, the filter assembly includes a filter support that supports the filter element, and wherein the filter support is a flexible mesh that covers one end of the slide element and that include outer portions between the third sealing member and the groove to hold the filter element and the filter support in place.

According to at least one example embodiment, a filter assembly for collecting bio-samples includes a hollow slide element with a groove on an outer side surface of the slide element, a sealing member within the groove, and a filter element that covers one end of the slide element to filter at least one material containing the bio-samples. An outer portion of the filter element is between the sealing member and the groove to hold the filter element in place.

### BRIEF DESCRIPTION OF THE DRAWINGS

The present disclosure is described in conjunction with the appended figures, which are not necessarily drawn to scale:

FIG. 1 illustrates an exploded view of a sample collector according to at least one example embodiment;

FIG. 2 illustrates a cross-sectional and assembled view of the sample collector according to at least one example embodiment;

FIG. 3 illustrates a close-up view of a portion of the sample collector of FIG. 2 according to at least one example embodiment;

FIG. 4 illustrates an exploded view of a filter assembly of the sample collector of FIGS. 1-3 according to at least one example embodiment;

FIG. 5 illustrates a plan view and a cross-sectional view of the slide element of the filter assembly of FIG. 4 according to at least one example embodiment;

FIG. 6 illustrates a cross sectional view of the sleeve in FIGS. 1-3 according to at least one example embodiment; and

FIG. 7 illustrates cross-sectional view of a cover of the sample collector in FIGS. 1-3 according to at least one example embodiment.

### DETAILED DESCRIPTION

An underwater biological sampling system (e.g., a plankton sampler) uses a novel system of small sample “pucks” that store and isolate each sample. The puck can be disassembled, the sample taken and the puck reassembled manually and/or automatically by the sampling system. During this process and before each sample, the system is sterilized and, after the sample is taken, a preservative is injected into the puck. At least 3 samples can be taken in sequence, meaning the sample water flows first through a coarse, then medium and then fine particulate (e.g., zooplankton, phytoplankton, bacteria, suspended sediments, geochemical tracers, and/or nutrients) removal filter. This sequential filtration is known as selective enrichment and enables organism samples of different sizes to be isolated and collected.

The quantity of samples, isolation between samples, and ability for selective enrichment are unique in the market and a highly beneficial instrument for the marine biologist tool kit. The present disclosure can provide a number of advantages depending on the particular aspect, embodiment, and/or configuration. The sampling system can have a high sample capacity (e.g., 600 samples), user selectable filter size, sterilizer, and preservative injection. The sampling system may, via on board intelligence, operate autonomously. The sampling system may provide bacteria-grade samples with little or no (zero) cross-contamination by other organisms or samples. These and other advantages will be apparent from the disclosure.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably. The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any computer readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique. The term “means” as used herein shall be given its broadest possible interpretation in accordance with 35 U.S.C., Section(s) 112(f) and/or 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element. The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

An example of the sampling device disclosed herein is known as a Plankton Sampler. The sampling system can, for autonomous operation, have an ROV took skid and winch lowered water column frame for seafloor deployment and an RS232 and Ethernet communication capability to host for trigger and status monitoring. A timer-based (e.g., autonomous) or manually triggered sampling procedure may be employed. Using on board processor and computer readable medium comprising instructions, the processor can execute filtration, preservative, and sterilizer protocols (e.g., sample times, sampling period, trigger mechanisms, preservative (e.g., Lugol's solution, high salt buffer, ethanol, or RNAlater) and sterilizer (e.g., sodium hypochlorite) volumes, and processes), which are user selected prior to deployment. The on board processing capability and communications interface can allow remote status monitoring while connected. The sampling system may include a tubular storage and exchanger mechanism that moves and/or sorts the pucks within the system in operation. This allows for each puck within the exchanger to collect a different sample, if desired.

The sample pucks can be reusable and have one or more replaceable filters, with the filter size(s) being user selectable. A typical puck comprises a bottom, side and top surface. The top and bottom surfaces can be perforated to enable seawater movement through the puck. The filter element is located inside the puck housing. The independent and sealable puck design comprises a slide, a cover slide, an outer sleeve, a first filter (e.g., 47 mm filter membrane), a second filter (e.g., 47 mm 80 micron mesh), a first “O”-ring, and a second “O”-ring. The various components can be disassembled for used filter removal and new filter replacement. The sampling device can have multiple external environmental sensors with RS232 communications capability. Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® 5 Cortex™-M processors, ARM® Cortex-A and ARM926EJ-S™ processors, other industry equivalent processors, and may perform computational functions using any known or future developed standard, instruction set, libraries, and/or architecture. Any of the steps, functions, and operations discussed herein can be performed continuously and automatically.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure. The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations thereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate embodiment of the disclosure. Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Various aspects of the example embodiments will be described herein with reference to drawings that are schematic illustrations of idealized configurations. It should be appreciated that while particular circuit configurations and circuit elements are described herein, example embodiments are not limited to the illustrative circuit configurations and/or circuit elements depicted and described herein. Specifically, it should be appreciated that circuit elements of a particular type or function may be replaced with one or multiple other circuit elements to achieve a similar function without departing from the scope of example embodiments.

It should also be appreciated that example embodiments described herein may be implemented in any number of form factors. Specifically, the entirety of the circuits disclosed herein may be implemented in silicon as a fully-integrated solution (e.g., as a single Integrated Circuit (IC) chip or multiple IC chips) or they may be implemented as discrete components connected to a Printed Circuit Board (PCB).

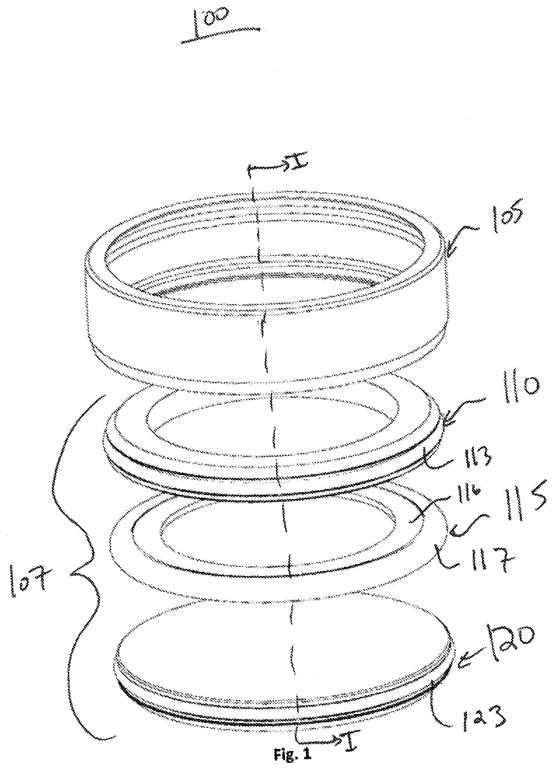

FIG. 1 illustrates an exploded view of a sample collector 100 according to at least one example embodiment. The sample collector 100 includes a cylindrically shaped hollow sleeve 105 and a removable sampler assembly 107 within the sleeve 105. The sampler assembly 107 includes a filter assembly 115 for filtering at least one material, such as an underwater biological organism. The sampler assembly 107 includes a first cover 110 including a first sealing member 113 to seal a first end of the filter assembly 115 in the sleeve 105. The sampler assembly 107 includes a second cover 120 including a second sealing member 123 to seal a second end of the filter assembly 115 in the sleeve 105. The first cover 110 and the second cover 120 may be identical to one another so that both covers 110 and 120 can be manufactured by the same process. The filter assembly 115 includes a hollow (e.g., ring-shaped) slide element 116 to hold an optional third sealing member 117. The sleeve 105, the first cover 110, the second cover 120, and the slide element 116 may be comprised of a durable resin or other polymers, such as acetal and the like.

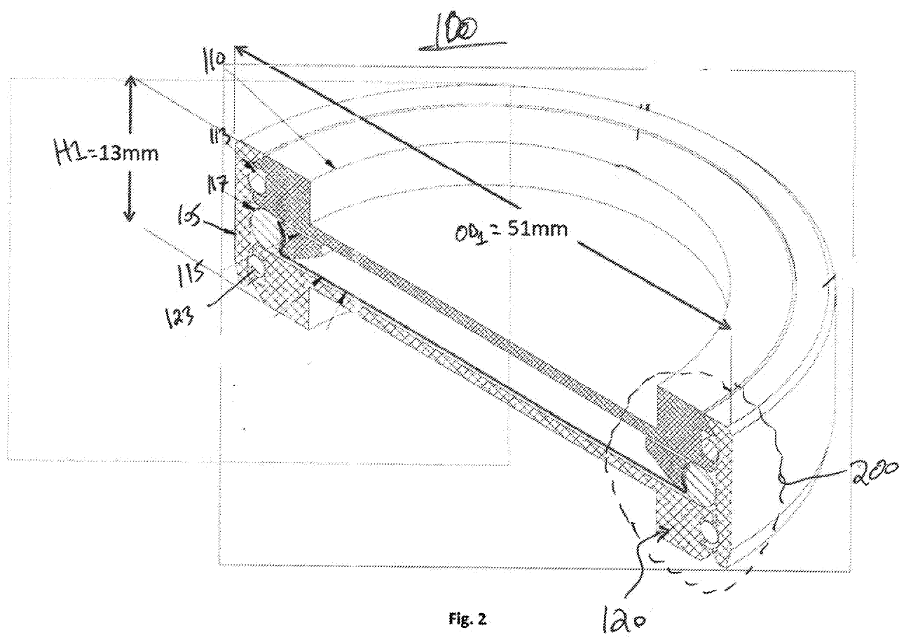

As shown in FIG. 1, the sleeve 105, the filter assembly 115, the first cover 110 and the second cover 120 are circular so that the assembled sample collector 100 is puck-shaped (see FIG. 2). However, example embodiments are not limited thereto and the sleeve 105, the filter assembly 115, the first cover 110 and the second cover 120 may have any desired shape, such as rectangular or other polygonal shapes. Details of the sleeve 105, the first cover 110, the filter assembly 115, and the second cover 120 are described further with reference to FIGS. 2-7.

FIG. 2 illustrates an assembled cross-sectional view of the sample collector 100 of FIG. 1 taken along line I-I according to at least one example embodiment. As shown in FIG. 2, the filter assembly 115 includes the third sealing member 117 between the first sealing member 113 and the second sealing member 123 within the sleeve 105. As also shown in FIG. 2, an outer diameter OD1 of the sample collector 100 (i.e., an outer diameter of the sleeve 105) is about 51.0 mm while a height H1 of the sample collector 100 (i.e., the sleeve 105) is about 13.0 mm. However, it should be understood that these dimensions and all other dimensions described herein may vary according to manufacturing tolerances and/or desired design parameters of a sampling system that includes the sample collector 100.

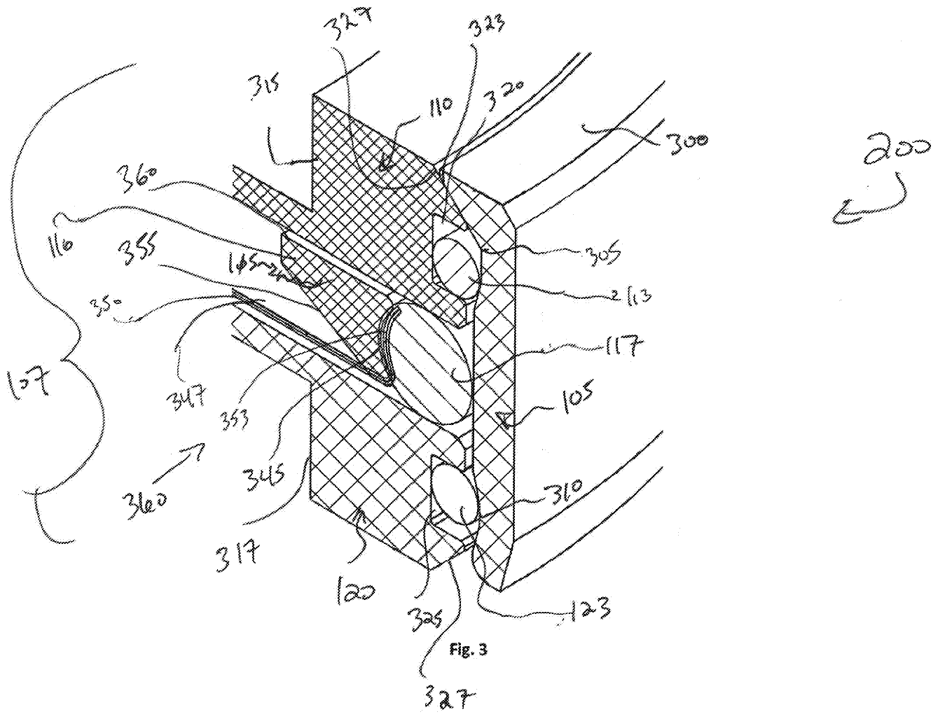

FIG. 3 illustrates a close-up view of a portion of the sample collector 100 of FIG. 2 according to at least one example embodiment. More specifically, FIG. 3 illustrates the view 200 shown in FIG. 2.

As shown in FIG. 3, a first end of the sleeve 105 includes a stopper 300 to prevent the sampler assembly 107 from being removed from the sleeve 105 through the first end. As shown in FIG. 1, the stopper 300 extends around an entire perimeter of the sleeve 105. Although not explicitly shown, it should be understood that the stopper 300 may extend around a partial perimeter of the sleeve 105, or include stopper portions formed at desired intervals around the perimeter of the sleeve 105. A second end of the sleeve 105 includes an opening 360 that allows for removal of the sampler assembly 107 from the second end of the sleeve 105.

According to at least one embodiment, the stopper 300 includes a chamfered (or angled) inner edge 323 of the first end of the sleeve 105 and a substantially flat top surface that is coplanar with a top surface of the first cover 110. However, the top surfaces of the stopper 300 and the first cover 110 may be offset if desired. The first cover 110 includes a chamfered outer edge 327 that corresponds to (or abuts) the chamfered inner edge 323 of the first end of the sleeve 105. The chamfered inner edge 323 and the chamfered outer edge 327 extend around an entire perimeter of sleeve 105 and the first cover 110, respectively, so as to provide additional sealing between the sleeve 105 and the first cover 110. According to at least one embodiment, the second cover 120 also includes a chamfered outer edge 327 identical to that of the first cover 110, and a bottom surface of the second cover 120 is coplanar with a bottom surface of the sleeve 105. However, the bottom surfaces of the second cover 120 and sleeve 105 may be offset if desired.

As shown in FIG. 3, the first cover 110 and the second cover 120 include respective grooves 323 and 325. That is, outer side surfaces of the first cover 110 and the second cover 120 include respective grooves 323 and 325. The grooves 323 and 325 may extend around an entire perimeter of the first and second covers 110 and 120. The first sealing member 113 and the second sealing 123 member are in the respective grooves 323 and 325. The filter assembly 115 includes the slide element 116 to hold the third sealing member 117. For example, as shown in FIG. 3, an outer side surface of the slide element 116 includes a respective groove 345, and the third sealing member 117 is in the respective groove 345 of the outer side surface of the filter assembly 115. The first sealing member 113, the second sealing member 123 and the third sealing member 117 provide a water-tight seal to protect material collected by the filter element 347.

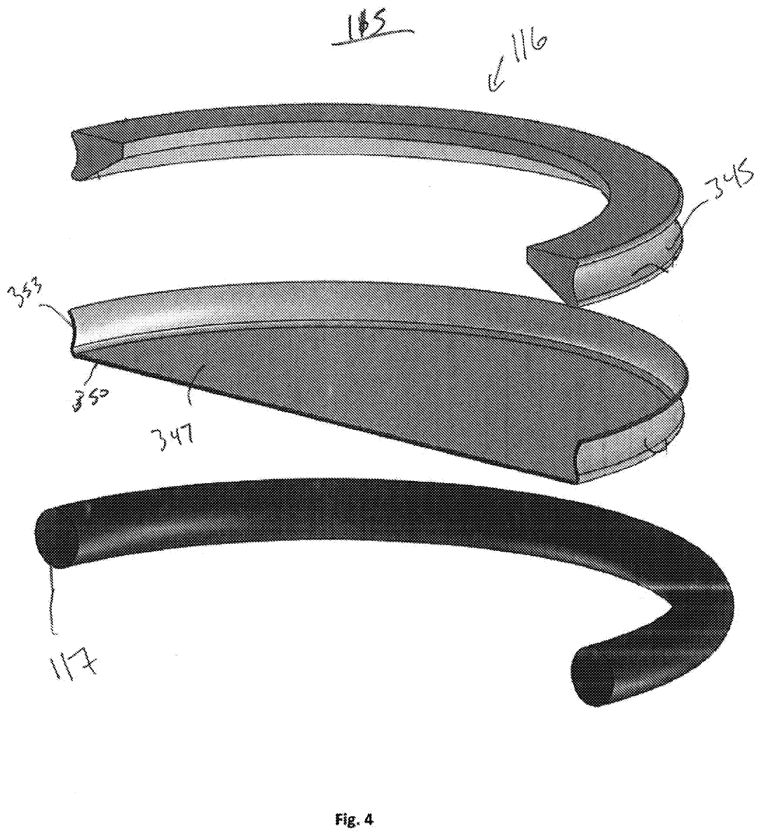

In one embodiment, the first, second and third sealing members 113, 117, and 123 are ring-shaped flexible elements, such as O-rings comprised of rubber or other sealing material such as nitrile, synthetic rubber, silicone and/or the like. The ring-shaped flexible elements corresponding to the first sealing member 113 and the second sealing member 123 may have same inner diameters that are greater than or equal to an inner diameter of the flexible element corresponding to the third sealing member 117. According to one embodiment, the grooves 323 and 325 are rectangular shaped while the groove 345 is a rounded concave shape with a desired radius of curvature. However, it should be understood that that the sizes and shapes of the grooves and the flexible elements and the relative inner diameters of the flexible elements may be varied according to design preference. Dimensions and other details of the grooves and sealing members are discussed in more detail below with reference to FIGS. 4-7.

Still referring to FIG. 3, the first cover 110 and the second cover 120 may include step portions 315 and 317, respectively. The size of the step portions 315 and 317 may be determined based on design parameters, such as a desired stability of the sample collector 100 and/or desired friction between top surfaces of the first cover 110 and the second cover 120 and an exchanger of a sampler system (not shown) that includes one or more sample collectors 100.

As shown in FIG. 3, the filter assembly 115 includes a hollow slide element 116 with a groove 345 on an outer side surface of the slide element 116 to hold the third sealing member 117. Further, the filter assembly 115 includes a filter element 347 that filters at least one material. The filter element 347 may be comprised of polyethersulfone (PES) of about 0.05 microns to about 5.00 microns, a mesh of glass fibers of greater than about 1.00 micron, nylon or polyester meshes of between about 10.0 microns and about 1000.0 microns, nylon membranes of about 0.1 to about 3.0 microns, and/or the like. According to one embodiment, the filter assembly 115 includes an optional filter support 350 that supports the filter element 347. The filter support 350 may be a woven mesh comprised of polyester, nylon, pliable metal, and/or the like. In any event, the filter element 347 and/or the filter support 350 are flexible meshes (about 47 mm in diameter) that cover one end of the slide element 116 and that include outer portions 353 between the third sealing member 117 and the groove 345 to hold the filter element 347 and/or the filter support 350 in place. A bottom surface of the filter element 347 (or the filter support 350 if included) abuts with a substantially flat top surface of the second cover 120.

At least one surface of the slide element 116 is chamfered. For example, FIG. 3 shows a chamfered surface 355 that faces the filter element 347. A top surface 360 of the slide element 116 is substantially flat and abuts with a substantially flat surface of the first cover 110.

According to one embodiment, at least one end of the sleeve 105 and at least one of the first and second covers 110 and 120 are held together at a connection point. In FIG. 3, the connection point includes at least one groove 305 (and/or groove 310) on an inner side surface(s) of the sleeve 105 (e.g., at top and/or bottom areas of the sleeve 105) that corresponds to an outer edge of at least one of the first sealing member 113 and/or the second sealing member 123. This allows for a detent connection of the sampler assembly 107 within the sleeve 105 (which can be achieved by manually, with or without the assistance of specialized tools) by sequentially inserting the first cover 110, the filter assembly 107 and the second cover 120 into the opening 360 of the sleeve 105. It should be understood that other connections between the sleeve 105 and the first and second covers 110 and 120 are possible, such as a snap fit, a snug fit, and/or a rotational locking/unlocking connection. The rotational locking/unlocking connection may comprise one or more vertical grooves with one or more corresponding horizontal grooves (e.g., so that a pair of vertical and horizontal grooves form a sideways 1′ shape) on inner side surfaces of the sleeve 105 and corresponding protrusions the first and/or second covers 110 and 120. An insert-and-twist operation is performed to lock the sampler assembly 107 into the sleeve and includes inserting the protrusion(s) into the vertical groove(s) and twisting the sampler assembly 107 or sleeve 105 to move the protrusion(s) into a horizontal groove(s). A twist-and-push/pull operation is performed to unlock and remove the sampler assembly 107 from the sleeve 105.

FIG. 4 illustrates an exploded cross sectional view taken along line I-I in FIG. 1 of a filter assembly 115 of the sample collector 100 of FIGS. 1-3 according to at least one example embodiment. As shown in FIG. 4, the filter assembly 115 includes at least three components, the slide element 116, the filter element 347, and the third sealing member 117. The filter assembly 115 can be assembled manually with or without the assistance of specialized tools. For example, if assembled manually, the filter element 347 and the filter support 350 begin as substantially flat workpieces. The slide element 116 is then placed on the flat filter element 347 and flat filter support 350 so that their outer portions 353 can be folded into the groove 345. The outer portions 353 are then folded into the groove 345 and secured by fitting the third sealing member 117 onto the outer portions 353 that are now within the groove 345.

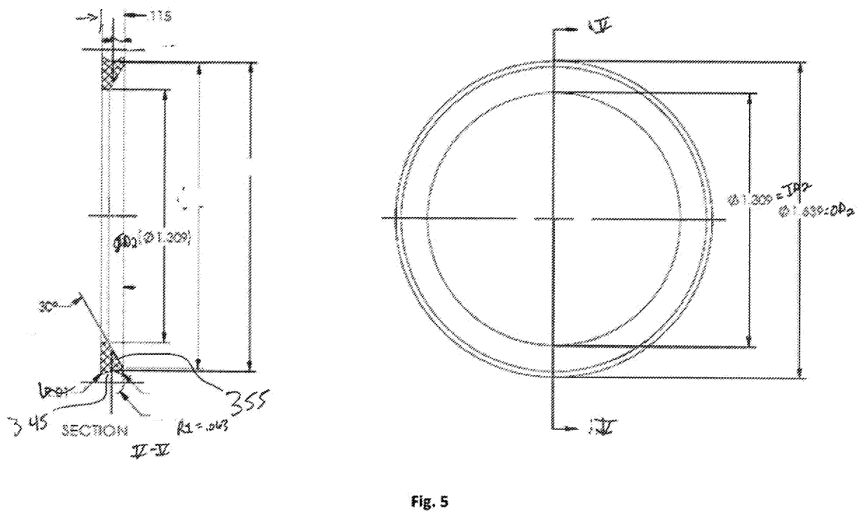

FIG. 5 illustrates a plan view and a cross-sectional view taken along the line V-V of the plan view of the slide element 116 of FIG. 4 according to at least one example embodiment.

As shown in the plan view of the slide element 116 in FIG. 5, the slide element 116 has an outer diameter OD2 of about 1.639 in. and an inner diameter ID2 of about 1.309 in. As shown in the cross sectional view taken along line V-V, the groove 345 has a radius of curvature R1 of about 0.063 in. A height H2 of the slide element 116 is about 0.115 in. and an inclination angle of the chamfered surface 355 is about 30°.

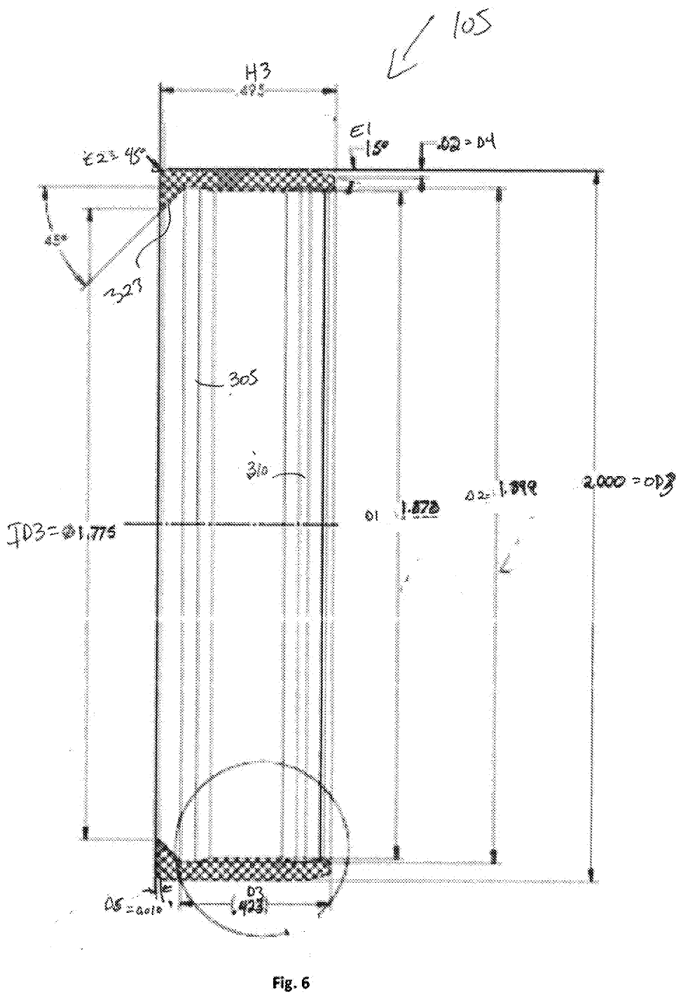

FIG. 6 illustrates a cross sectional view of the sleeve 105 in FIGS. 1-3 according to at least one example embodiment.

As shown in FIG. 6, the sleeve 105 has an outer diameter OD3 of about 2.000 in and an inner diameter ID3 of about 1.775 in. The sleeve 105 has a height H3 of about 0.495 in., and an inclination angle of the chamfered edge 323 is about 45°. A distance D1 from an inner surface of grooves 305 and 310 on one side of the slide 105 to an inner surface of the grooves 305 and 310 on an opposite side of the sleeve 105 is about 1.899 in. A distance D2 from a non-grooved inner surface of the sleeve 105 to an opposing non-grooved surface of the sleeve 105 is about 1.878 in. Thus, the grooves 305 and 310 are about 0.021 in. deep and have angles of inclination of about 15°. A length of the inclinations of each groove 305 and 310 is about 0.04 in. A distance D3 from one end of the sleeve 105 to the beginning of the chamfered edge 323 is about 0.423 in. A bottom outer edge E1 of the sleeve 105 has an angle of inclination of about 15° so that a distance D4 is about 0.02 in. A top outer edge E2 of the sleeve 105 has an angle of inclination of about 45° so that a distance D5 is about 0.010 in. The angles of edges E1 and E2 may allow for ease of insertion and removal with an exchanger of a sampler system that uses one or more sample collectors 100. A radius of curvature of a portion between edge E1 and a bottom surface of the sleeve 105 is about 0.025 in.

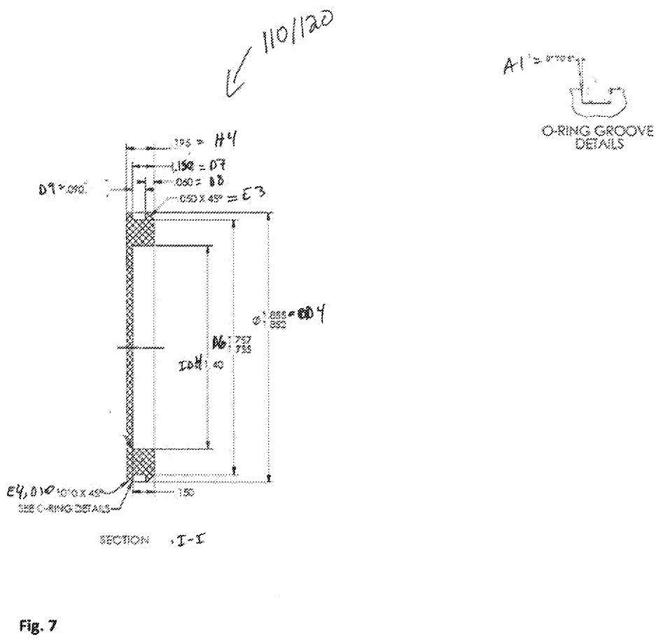

FIG. 7 illustrates cross-sectional view of first and second covers 110/120 (referred to as cover 110/120 for the sake of convenience) of the sample collector 100 in FIGS. 1-3 according to at least one example embodiment.

As shown in FIG. 7, the cover 110/120 has a height H4 of about 0.195 in, an outer diameter OD4 of about 1.855 in. and an inner diameter ID4 of about 1.400 in. An edge E3 of the cover 110/120 has an angle of inclination of about 45° to match the chamfered edge 323 of the sleeve 105. A distance D6 is about 1.757 in., a distance D7 is about 0.150 in., a distance D8 is about 0.060 in., and a distance D9 is about 0.090 in. An edge E4 has an angle of inclination of about 45° so that distance D10 is about 0.010 in. As shown in the close-up of the O-ring groove detail, an angle A1 is about 0° to about 5°.

In view of the foregoing, it should be appreciated that example embodiments provide for underwater sampling devices and methods that allow for convenient collection of samples in an underwater environment. Furthermore, the sample collector, which includes a filter assembly and a sampler assembly, is easily manufactured and assembled/disassembled to allow for convenient use in the field.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A sample collector, comprising:
a hollow sleeve; and
a removable sampler assembly within the sleeve, the sampler assembly including,
a filter assembly including a filter element for filtering at least one material,
a first cover including a first sealing member to seal a first end of the filter assembly in the sleeve, and
a second cover including a second sealing member to seal a second end of the filter assembly in the sleeve.

2. The sample collector of claim 1, wherein the sleeve, the filter assembly, the first cover and the second cover are puck-shaped.

3. The sample collector of claim 1, wherein the filter assembly includes a third sealing member between the first sealing member and the second sealing member within the sleeve.

4. The sample collector of claim 3, wherein the filter assembly includes a hollow slide element with a groove on an outer side surface of the slide element to hold the third sealing member, and
wherein the filter assembly includes a filter support that supports the filter element.

5. The sample collector of claim 4, wherein the filter element and the filter support are flexible meshes that cover one end of the slide element and that include outer portions between the third sealing member and the groove to hold the filter element and the filter support in place.

6. The sample collector of claim 3, wherein outer side surfaces of the first cover and the second cover include respective grooves, and
wherein the first sealing member and the second sealing member are in the respective grooves.

7. The sample collector of claim 6, wherein the filter assembly includes a slide element to hold the third sealing member,
wherein an outer side surface of the slide element includes a respective groove, and
wherein the third sealing member is in the respective groove of the outer side surface of the filter assembly.

8. The sample collector of claim 7, wherein the first, second and third sealing members are ring-shaped flexible elements, and
wherein the flexible elements corresponding to the first sealing member and the second sealing member have same inner diameters that are greater than an inner diameter of the flexible element corresponding to the third sealing member.

9. The sample collector of claim 7, wherein at least one surface of the slide element is chamfered.

10. The sample collector of claim 1, wherein a first end of the sleeve includes a stopper to prevent the sampler assembly from being removed from the sleeve through the first end.

11. The sample collector of claim 10, wherein a second end of the sleeve includes an opening that allows for removal of the sampler assembly from the second end.

12. The sample collector of claim 10, wherein the stopper is a chamfered inner edge of the first end of the sleeve.

13. The sample collector of claim 12, wherein at least one of the first cover and the second cover includes a chamfered outer edge that that corresponds to the chamfered inner edge of the first end of the sleeve.

14. The sample collector of claim 1, wherein at least one end of the sleeve and at least one of the first and second covers are held together at a connection point.

15. The sample collector of claim 14, wherein the connection point is detent connection that includes at least one groove on an inner side surface of the sleeve that corresponds to an outer edge of at least one of the first sealing member and the second sealing member.

16. A sampler assembly, comprising:
a filter assembly including a filter element for filtering at least one material,
a first cover including a first sealing member to seal a first end of the filter assembly in a sleeve, and
a second cover including a second sealing member to seal a second end of the filter assembly in the sleeve.

17. The sampler assembly of claim 16, wherein outer side surfaces of the first cover and the second cover include respective grooves, and
wherein the first sealing member and the second sealing member are in the respective grooves.

18. The sampler assembly of claim 17, wherein the filter assembly includes a hollow slide element to hold a third sealing member between the first sealing member and the second sealing member in the sleeve,
wherein an outer side surface of the slide element includes a respective groove,
wherein the third sealing member is in the respective groove of the outer side surface of the filter assembly, and
wherein the filter element is a flexible mesh that covers one end of the slide element and that includes an outer portion between the third sealing member and the respective groove of the slide element to hold the filter element in place.

19. The sample assembly of claim 18, wherein the filter assembly includes a filter support that supports the filter element, and wherein the filter support is a flexible mesh that covers the one end of the slide element and that includes an outer portion between the third sealing member and the groove to hold the filter element and the filter support in place.

20. A filter assembly for collecting bio-samples, comprising:
a hollow slide element with a groove on an outer side surface of the slide element;
a sealing member within the groove; and
a filter element that covers one end of the slide element to filter at least one material containing the bio-samples, an outer portion of the filter element being between the sealing member and the groove to hold the filter element in place.
